(19) United States
(12) Patent Application Publication
(10) Pub. No.: US 2003/0021996 A1
(43) Pub. Date: Jan. 30, 2003

(54) Release surfaces

(76) Inventors: Yuri Gudimenko, North York (CA); Grant Cool, Richmond Hill (CA); Richard Ng, Markham (CA)

Correspondence Address: FAY, SHARPE, FAGAN, MINNICH & McKEE, LLP, Seventh Floor, 1100 Superior Ave., Cleveland, OH, 44114-2518, US

(21) Appl. No.: 09/827,710

(22) Filed: Apr. 6, 2001

(51) Int. Cl. B32B 27/00; B32B 27/38; B32B 27/06; B32B 27/08; B32B 27/34; B32B 27/36

(52) U.S. Cl. 428/411.1; 204/157.15; 204/164; 428/473.5; 428/477.7; 428/480; 428/447; 428/413

(57) ABSTRACT

A process for the production of solid polymeric or composite substrates having surfaces with enhanced release properties is described. The process comprises (a) surface activation and (b) surface silylation and room temperature vulcanization (RTV) curing of the surface of a solid polymeric or composite substrate.

### CROSS REFERENCE TO RELATED APPLICATIONS

### FIELD OF THE INVENTION

This invention relates to a process for the modification of solid substrates, such as polymers and composite materials, which produces new materials having enhanced surface characteristics, for example enhanced release properties.

### BACKGROUND OF THE INVENTION

Today there are a wide variety of chemistries and techniques used to provide release properties (the opposite of adhesion) from a pressure-sensitive adhesive or tacky material. Silicone-based release coatings dominate the market because they have a reliably low release force as compared to other coatings.

Silicones have been used in one form or another in release coating technologies for over 40 years, for examples see D. Satas, Handbook of Pressure Sensitive Adhesive Technology, 1989, NY.

To get release properties it is typically necessary to cross-link the silicone material. Traditionally these cross-linking reactions for silicone materials are thermally initiated and occur by either an addition or a condensation mechanism. The components of a thermally cured silicone release system are usually a reactive polymer, a cross-linker, and a catalyst. In general, systems that require curing have many disadvantages. For example the components in such a cured system are usually quite reactive and are hard to maintain in a stable form, or are easily contaminated by moisture.

Radiation curing of silicone is another method used to get the required cross-linking for release properties. High intensity ultraviolet light or an electron beam (EB) can be used. Radiation based processes can be made highly productive due to fast curing rates, and are usually cleaner and easy to use and maintain than the thermal curing mechanisms. Although there are many advantages to radiation curing, it would be unwise to suggest that there are no disadvantages to this technology. Some disadvantages are: higher raw material costs, higher raw material viscosities that make handling and uniform coating difficult, skin irritation by raw materials (low molecular weight acrylate monomers), poor adhesion to some substrates (plastic, vinyl, metal), and higher equipment costs in the case of EB.

When one looks at the broader silicone process industry (beyond release coatings), the most common curing method is room temperature vulcanization (RTV) curing. This does not apply to silicone based release coatings where RTV curing is only at the development stage, for example, U.S. Pat. No. 4,530,882 and D. J. Huettner, “Moisture Curing Silicone Release Coating Technology: A Coating Process is the Missing Component”, Pressure Sensitive Tape Council Technical Seminar, 1988.

U.S. Pat. No. 5,286,815 describes moisture curable polysiloxane release coating compositions, which were created to overcome some formidable difficulties peculiar to RTV systems. These compositions consist of polysiloxane component, alkoxysilane, solvent, and catalyst.

Typically, moisture curable materials are manufactured by end-capping α, ω-silanol terminated silicones with various cross-linkers such as alkoxysilanes, oximinosilanes, acetoxysilanes, aminosilanes, and other silanes with hydrolysable groups attached to the silicon atom(s). During application the material is exposed to ambient conditions for curing. The moisture in the air will hydrolyze the hydrolysable groups (alkoxy, oximino, acetoxy, amino, etc.) on the silicon atom(s), to form silanol. A catalyst is sometimes used. The resulting silanol can then further react with the silanol-terminated silicones or remaining unhydrolyzed groups in a condensation reaction, to form a siloxane linkage, which cures silicone material. Suitable moisture cure catalysts for these formulations include dibutyltin diacetate. The same type of the catalysts can be applied for the dehydrogenative coupling reaction between a silanol-functional polymer and a silane-hydride functional cross-linker.

Moisture curable silicone compositions consisting of mixtures of predominantly polydiorganosiloxanes having two or more terminal and/or pendant trialkoxysilyl substituents and lesser amounts of tetraalkyl titanate esters provide silicone release coatings that cure exceptionally rapidly under ambient conditions (See, for example, U.S. Pat. Nos. 4,743,474; 4,530,882; and 4,525,566)

A proposed alternative to curable systems is the use as a coating comprising a block, segmented or graft copolymer having polyorganosiloxane segments and self-associated hard segments. This type of copolymer is capable of forming a solid, generally non-tacky release coating without the requirement of curing as described in U.S. Pat. No. 5,866,222 and references cited therein. This copolymer can be extrudable as a thermoplastic material or coated out of solvent. However, multi-stage synthesis procedure, solvents, and finally, multi-component mixture are not desirable in many applications.

### SUMMARY OF THE INVENTION

The present invention provides a new process for producing release surfaces with significant processing advantages over current approaches. According to the present invention, a silylation agent is reacted on the surface of an activated substrate while simultaneously modifying a sub-surface layer of the substrate and forming a room temperature vulcanized (RTV) cured coating on the surface.

It is an object of this invention to produce silicon-enriched surfaces with good permanent release properties.

It is an object of this invention to produce silicon-enriched surfaces that are suitable for release of pressure sensitive adhesives and tacky industrial materials.

### BRIEF DESCRIPTION OF THE DRAWINGS

Further aspects and advantages of the present invention will be apparent from the following description taken together with the accompanying drawings in which:

FIG. 1 is a sectional, side elevation schematic view showing the structure of a preferred surface-modified material according to the present invention;

FIG. 2 is a table showing results from a silicon transfer test.

### DETAILED DESCRIPTION OF THE INVENTION

The surface modification process according to the present invention comprises the following two steps:

1. Surface activation of the solid substrate, wherein reactive hydrogen groups such as OH, OOH and COOH are formed in a sub-surface region of the substrate material;

and

2. Treatment of the activated surface with a silylation solution. This treatment includes silylation of at least a portion of the reactive hydrogen groups in the surface region of the substrate with a silylating agent, whereby silicon-containing groups of the silylating agent become incorporated in the surface region of the substrate. In the presence of atmospheric water (relative humidity higher than 25%) a parallel condensation reaction takes place producing a moisture cured, RTV, coating.

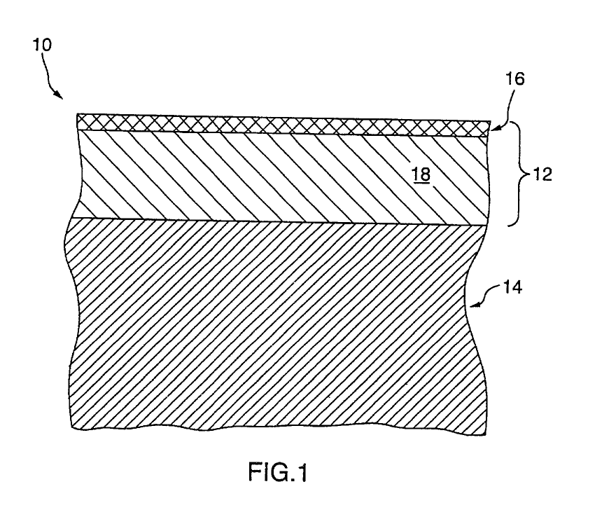

FIG. 1 schematically illustrates a surface modified substrate 10 having an RTV cured release coating 16 produced by a process according to the present invention. Substrate 10 is shown as having a silylated surface region 12 and underlying unmodified bulk substrate 14. Surface region 12 is produced according to the present invention by, first, a surface activation step wherein reactive hydrogen groups are produced in surface region 12. After activation, in a second step, the surface modified layer of the original substrate 12 is silylated and the RTV release-coating 16 is produced simultaneously from the silylation chemicals. For convenience, FIG. 1 shows surface region 12 and bulk substrate 14 being separated by a sharp interface. However, it is to be understood that the transition between surface region 12 and bulk substrate 14 is graded and no identifiable interface exists. Further, it is to be appreciated that the distribution of the reactive hydrogen groups in the surface region 12 after the activation step, as well as the distribution of the silicon-containing groups in the surface region after silylation, is graded such that the concentration of such groups is highest at the surface of the surface region 12 and gradually decreases inward of the surface of the substrate.

Release-coating 16 is formed by an RTV process of the silylation chemicals simultaneous to the silylation reaction in surface region 12. Release-coating 16 is a highly cross-linked silicone containing structure, covalently bonded to the surface region 12 during the simultaneous RTV curing and silylation process.

It is to be understood that the silicon and oxygen content of the outer portion 16 of surface region 12 is highest at the surface of the substrate and gradually decreases inward of the surface.

Activation

In accordance with the invention, the surface of a substrate is activated. The surface activation step comprises exposure of the substrate to for example, a corona discharge or a combination of UV radiation and oxygen, thus photo-oxidizing the substrate.

The surface activation is carried out under conditions that lead specifically to the formation of a high concentration of reactive hydrogen groups in a surface region of the substrate, the reactive hydrogen groups being COOH, OOH and OH. It is to be appreciated that these reactive hydrogen groups are chemically bonded to the polymer molecules comprising the surface region of the substrate. Preferably, a graded transition is formed between the activated surface region and the underlying, unmodified substrate, referred to throughout this specification as the “bulk substrate”. Within the graded transition region the concentration of reactive hydrogen groups created during the activation process decreases with depth.

A preferred surface activation step of the present invention comprises formation of reactive hydrogen groups in a surface region of a solid substrate by corona discharge treatment. The treatment of surfaces by corona discharge in air at atmospheric pressure is a well-established technology. The material oxidation due to the glow effect proceeds through chemical modifications evenly spread on the surface of a substrate. In ambient corona discharge treatment the electrical discharge produces electrons, ions and radicals species that impinge on the polymer surface and initiate free radical reaction sequences creating functional groups on the surface of a substrate. The majority of the functional groups incorporated by corona discharge treatment contain oxygen.

Silylation

After surface activation, the reactive hydrogen groups in the surface region of the substrate are reacted with a silylating agent. By reacting the activated surface with a silylating agent, the hydrogen atoms of the active hydrogen groups are replaced by silicon-containing groups. Silylating agents which are useful in accordance with the process of the present invention are those containing organosilicon groups that, in turn, are incorporated into the polymer molecular structure of the surface region of the substrate. The silylation reaction may either be a “vapour phase” reaction wherein the surface of the substrate is exposed to a vapour of the silylating agent, or may be a “liquid phase” reaction wherein the surface of the substrate is contacted with a solution containing the silylating agent, by dipping, spraying, rolling or some other method known in the art.

In accordance with the invention, the degree of silylation is such that substantially all of the reactive hydrogen groups formed by the activation step are replaced by silicon-containing groups. The high density of reactive hydrogen groups produced in the surface region of the substrate provides a large number of reactive sites for the silylating agent to react with. This allows a high concentration of silicon to be incorporated into the surface region of the substrate. This capability to incorporate a high concentration of silicon into the surface region of the substrate is at least partially responsible for the release properties of the surface of this invention. If the unreacted silylating agent were rinsed off after a short exposure to the surface, the new surface created would exhibit release properties. This surface modification can be used as a release surface alone. However, it has been found that the non-uniformity of the original substrate can substantially affect the capability of the new release surface to perform in industrial applications. This pre-existing non-uniformity causes irregular/uneven release performance over the surface of the silylated substrate. Some areas have better release characteristics than others. The silylation based surface modification as described above, alone, cannot eliminate the non-uniformity. In some applications, such as commodity backing for stickers and labels, this may not be problem. In most other utilities where release performance is critical, this would be unacceptable.

The key to eliminating this problem of non-uniformity is to cover such a non-uniform surface with a coating. This can be simply done by polymerizing the unreacted silylation solution in the presence of moisture rather than rinsing it off. Cross-linking agents and moisture cure catalysts can be added to the silylation solution before it is placed on the surface. As the silylation reaction occurs, which thereby incorporates silicon into the substrate, the silylation solution is polymerizing to form a relatively flat layer. A graded transition is formed between the modified surface region of the substrate and the underlying bulk substrate. There is no sharp interface between the new material and the original substrate. Sharp interfaces are not formed because the process simultaneously modifies a subsurface layer of the original substrate and forms a coating, as contrasted with a coating which is deposited on top of the surface of the substrate.

The surface modification process of the present invention can be successfully used on substrates in virtually any form, including, but not limited to, thin films, coatings, shaped articles, fabrics and fibers. The process and the surface modified substrates according to the present invention may be useful in a variety of industries, such as packaging, automotive, electronic, biomedical, building products, textile, clothing, etc.

As noted herein before, the silylation step according to the present invention may be carried out as a vapor phase or liquid phase reaction, preferably using a silylating agent containing organosilicon groups. Such organosilicons can be selected from agents such as monofunctional and polyfunctional silylating agents.

Examples of monofunctional silylating agents include, but are not limited to, dimethylsilyldimethylamine (DMSDMA), 1,1,3,3-tetramethyldisilazane (TMDS), N,N-dimethylaminotrimethylsilane (TMSDMA), N,N-diethylaminotrimethylsilane (TMSDEA) and hexamethyldisilazane (HMDS). In these monofunctional silylating agents, each silicon atom is bonded to one nitrogen atom. During the silylation reaction the Si—N bonds are broken, and each silicon atom forms one bond with the surface molecules of the substrate. The structures of these monofunctional silylating agents are as follows:

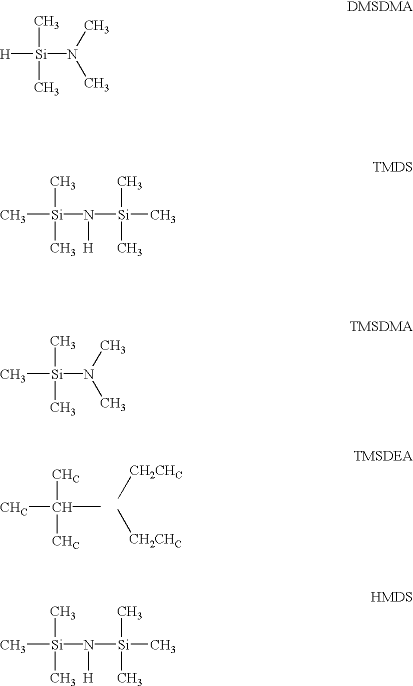

Examples of polyfunctional silylating agents include, but are not limited to:

Bis(dimethylamino)methylsilane (B[DMA]MS),

Bis(dimethylamino)dimethylsilane (B[DMA]DS),

Tris(dimethylamino)methylsilane (T[DMA]MS),

Tris(dimethylamino)silane (T[DMA]S),

1,2-Bis[(dimethylamino)dimethylsilyl]ethane B[DMA]DSE, and

1,1,3,3,5,5-Hexamethylcyclotrisilazane (HMCTS).

In each of these polyfunctional silylating agents, each silicon atom is bonded to at least two nitrogen atoms. When the Si—N bonds are broken, each silicon atom forms at least two bonds. These bonds may be formed with either the polymer molecules of the substrate or the molecules of the silylation solution. This results in cross-linking of the polymer molecules in the surface region of the substrate. Additionally, it is possible that a combined interaction between the substrate surface and components of the reaction mixture can be attained. The structures of the preferred polyfunctional silylating agents are as follows:

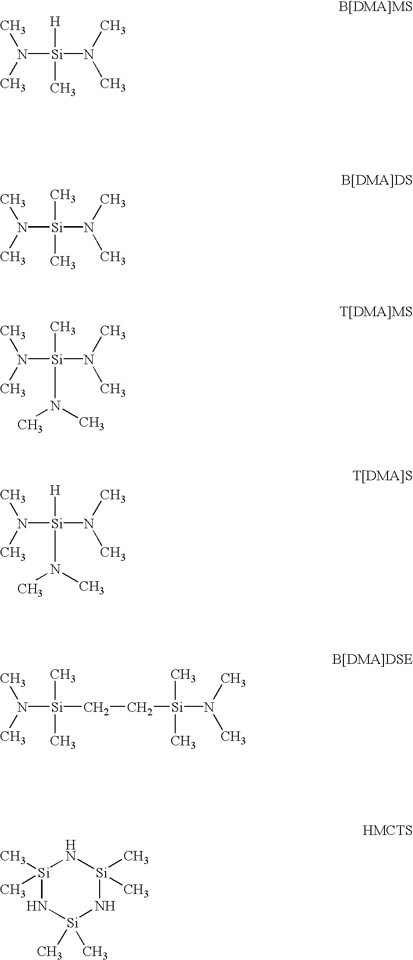

The liquid phase silylation solution is made up of at least one and possibly two or more different components. Some possible forms include, but are not limited to:

(1) silylating agent alone.

(2) silylating agent and a transport solvent.

(3) silylating agent and catalyst.

(4) silylating agent, cross-linker, and catalyst.

The silylating agent is, as previously outlined, the chemical agent that carries the necessary silicon atoms. The transport solvent acts as the solvent for the silylating agent, and should be relatively inert otherwise. The preferred silylating agents for liquid phase silylation are the polyfunctional silylating agents B[DMA]MS and B[DMA]DS. It is believed that polyfunctional silylating agents form a polysiloxane (Si—O—Si) chain on each reactive hydrogen group resulting in a higher content of silicon. Preferred solvents are those that act as a solvent for the particular silylating agent, and are inert toward the substrate, that is, they do not dissolve or severely swell the substrate. The most preferred solvents are aliphatic hydrocarbons, such as n-hexane, n-heptane, n-octane, n-nonane and n-decane or their fraction.

Preferred cross-linking agents can be any alkoxysilane of the formula:

RₙSi(OR¹)₄₋ₙ

Some examples of this type of silane include, but are not limited to:

CH₃Si(OCH₃)₃-Methyltrimethoxysilane (MTMS)

CH₃Si(OCH₂CH₃)₃-Methyltriethoxysilane (MTES)

Si(OCH₃)₄-Tetramethyl orthosilicate (TMOS)

Si(OCH₂CH₃)₄-Tetraethyl orthosiicate (TEOS)

Various silane-hydride functional cross-linkers can be applied as well, such as poly (methylhydrosiloxane) (PMHS), B[DMA]MS, T[DMA]S, and others.

Suitable moisture cure catalysts for use in the present invention include any such catalysts known in the art including but not limited to alkoxytitanium derivatives, for example tetraisopropyl titanate or titanium chelate catalysts; or tin-derived esters, such as dibutyltin dicarboxylates.

In accordance with a more limited embodiment of the invention, silylation is carried out at about 20° C. to about 70° C., the substrate being treated by roll, rod or spray, with a solution of silylating agent. The silylation agent concentration can be in the range from about 1.0 to about 100%. In other words, it is possible to form the RTV coating without cross-linking agents or catalysts. The substrate can also be immersed in the silylation solution if it is immediately removed for exposure to the ambient atmosphere. After silylation the surface must be exposed for about 2 seconds or more to the water vapour in the ambient atmosphere at relative humidity of about 30 to about 90%.

Temperature, humidity level, type of the catalyst, amount of catalyst, and modification thickness are the major parameters that influence the rate of cure. Heat and moisture accelerate the curing process.

Experimental

Corona Activation

For corona treatment, a system that consists of a conveyer and a Model BD-80 Electro-Technic Products Inc. high frequency single electrode corona surface treater was used. In this system, the treater was stationary and the sample was placed on a movable platform with adjustable speed. The distance between the electrode (either a steel-wire (diameter 1 mm) or a plastic-insulated steel-wire electrode) and the surface to be treated was adjustable from 2 to 5 mm.

Contact Angle Measurement

Contact angle measurement is a useful technique for assessing changes in surface chemistry. Water contact angle measurements were applied for all samples, using a Krüss G10 instrument along with its Drop Shape Analysis software for process control at all stages. The static contact angle of water on the sample was measured using a 6-microliter droplet at ambient conditions (T=20° C.) with the sessile drop method. The values reported are the average of at least five measurements.

Release Test Method

This test measures the effectiveness of the release modification initially and after a period of aging at room temperature or at an elevated temperature. The initial or aged release value is a quantitative measure of the peeling/release force necessary to remove a treated sample from a pressure-sensitive adhesive tape at a specific angle and rate of removal. The initial and aged release forces were determined in the following manner: a one-inch wide strip of an pressure-sensitive adhesive tape was rolled down onto the surface of the modified sample with a 4.5 lb rubber roller. The laminated tape/sample was allowed to age for the desired time/temperature/pressure conditions and was then adhered to a stainless steel plate with double-sided tape. The force required to peel the treated sample at a 90° angle at a peel rate of 300 inches per minutes was then measured, using a ChemInstruments Adhesion/Release tester (Model AR-1000). Three test conditions were evaluated 1) the testing tape was allowed to dwell in contact with the treated substrate for only 1 minute at room temperature, 2) 20 hours dwell, 10 lb load, 24° C. and 3) 20 hour dwell, 10 lb load, 70° C. Three types of pressure-sensitive adhesive tapes were applied: (1) C4704 from Avery Dennison; (2) HD11F4 from Avery Dennison; and (3) TESA® 7475. The mean values of at least three measurements are quoted, in grams per inch-width.

Adhesive Percent Retain Capability of the Tape

Another measure of the quality of the release surface is whether or not a drop in the adhesion strength of the tape occurred due to the transfer of any release component to the adhesive when the tape is peeled from the modified surface. This is determined by performing the Percent Retain Test. Percent Retain was calculated as a ratio between the force required to remove the testing tape from a stainless steel test panel after its contact with a treated release film sample and the force required to remove the same size original testing tape (no previous contact with treated sample) from the same clean test panel. The peel adhesion force was measured using the same Adhesion/Release tester and tapes indicated above, peeling at a 180° angle and at a constant rate of 12 inches per minute. A 4.5 lb rubber roller was used to apply the tape onto the test panel, and adhesion force was measured immediately without further dwell time. A good release surface should have 95 to 100% retain. Average values from at least three measurements are quoted.

Silicon Transfer Measurement

Dot Spread Silicon Contamination Test was employed to determine whether the modified substrate contains loosely bounded silicone particles, which can transfer to other surfaces. This highly sensitive test was conducted by rolling down a piece of 3M Scotch™ 810 tape onto the modified surface with a 4.5 lb rubber roller, peeling the tape off the surface, and then applying a 2-microliter droplet of the test dye solution (0.1% Crystal Violet in i-propanol) on the adhesive side of the tape. The degree of silicon transfer is determined by comparing the change in dot size of the applied dye solution on the testing tape, which had been previously adhered to the treated surface, versus the original (control—no previous contact with treated sample) tape. If transfer of silicone occurs, the surface energy of the adhesive on the tape changes resulting in a reduction in the spread of the dye solution. The size of the dot is then translated into the amount of silicone transferred. The smaller the dot size, the higher the amount of silicone transferred.

Zippy/Slip-Stick Sound

Zippy/Slip-Stick Sound during the peel release test provides a mean of assessing the quality and uniformity of the release modification. No noise or sound during the peeling process indicates a smooth, homogeneous, and uniform release surface. When the peeling process is accompanied by a tearing sound (i.e. zippy/slip-stick sound), which might be caused by a flapping of free release liner at the point of separation, indicates the release modification is uneven and non-uniform.

The following examples illustrate the results of surface modification processes according to the present invention on various types of polymers.

### EXAMPLE 1

A polyolefin film (homopolymer polypropylene with mica in the core) was activated by corona discharge using plastic-insulated steel-wire electrode with gap at 2 mm and at energy of 0.18 J/mm². After activation, the water contact angle of the surface dropped to 53° (Table 1). The film was then sprayed with a solution of 20% B[DMA]MS in n-heptane at room temperature (23° C.) and RH 30% and dried at the same conditions. The water contact angle after this stage has increased to 103° (Table 1). This indicates the hydrophobization of the surface, and confirms the surface modification.

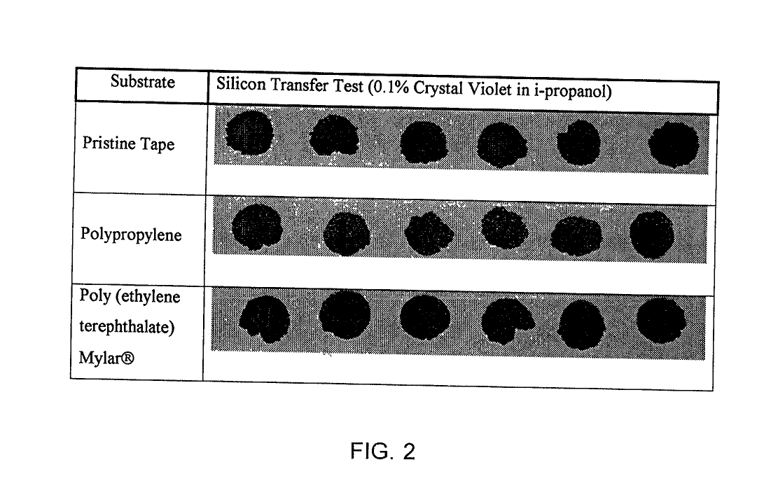

The following tests were conducted to evaluate the release and quality of the modification: (1) 90° Peel/Release (with and without aging), (2) Percent Retain and (3) Silicon Transfer. The results shown in Table 2 demonstrate the release properties of the treated polypropylene. The release force decreased from 1750 (untreated) to 30 g/inch-width (no aging) and increased to 52 g/inch-width after being adhered to the tape for 20 hours under a 10-lb load at 70° C. Average percent retain was 95±3 and the sample showed neither zippy/slip-stick sound (Table 2) nor silicon transfer (FIG. 2).

### EXAMPLE 2

Example 1 was repeated, except that the polypropylene film after silylation was dried at 65° C. and RH 100%. Release properties of the sample are presented in Table 2.

### EXAMPLE 3

Example 1 was repeated, except that the polypropylene film was sprayed with a solution of 20% B[DMA]MS in n-heptane at temperature 50° C. and RH 2% and dried at the same conditions. Release properties of the sample are presented in Table 2.

### EXAMPLE 4

Example 1 was repeated, except that the polypropylene film was activated by corona discharge using steel-wire electrode with gap at 2 mm and at energy of 0.18 J/mm². The film was then sprayed with a solution of 20% B[DMA]MS in n-heptane at temperature 50° C. and RH 2% and dried at 65° C. and RH 100%.

Release properties of the sample are presented in Table 2.

### EXAMPLE 5

Example 1 was repeated, except that the polypropylene film was sprayed with a solution of 20% B[DMA]MS in n-heptane at temperature 50° C. and RH 2% and dried at 65° C. and RH 100%. Release properties of the sample are presented in Table 2.

### EXAMPLE 6

Example 1 was repeated, except that the polypropylene film was sprayed with a solution of 10% B[DMA]MS in n-heptane at temperature 50° C. and RH 2% and dried at 65° C. and RH 100%. Release properties of the sample are presented in Table 2.

### EXAMPLE 7

Example 1 was repeated, except that the polypropylene film was sprayed with a solution of 5% B[DMA]MS in n-heptane at temperature 50° C. and RH 2% and dried at 65° C. and RH 100%. Release properties of the sample are presented in Table 2.

### EXAMPLE 8

Example 1 was repeated, except that the 100% B[DMA]MS was spread by a roller onto the surface of activated polypropylene film at room temperature 23° C. and RH 30% and dried at the same conditions. Release properties of the sample are presented in Table 2.

### EXAMPLE 9

A 2.0 mil thick poly(ethyleneterephthalate) MYLAR® film was activated by corona discharge using plastic-insulated steel-wire electrode with gap at 2 mm and at energy of 0.18 J/mm². After activation, the sample exhibited a water contact angle of 30° (Table 1). The film was then sprayed with a solution of 20% B[DMA]MS in n-heptane at temperature 50° C. and RH 2% and dried at 50° C. and RH 80%. The water contact angle of the sample after this stage has increased to 104° (Table 1). This indicates the hydrophobization of the surface, and confirms the surface modification. Release properties of the sample are presented in Table 3 and FIG. 2 (silicon transfer).

### EXAMPLE 10

Example 9 was repeated, except that the 100% B[DMA]MS was spread by a roller onto the surface of activated MYLAR® film at room temperature 20° C. and RH 30% and dried at the same conditions. Release properties of the sample are presented in Table 3.

### EXAMPLE 11

A fiberglass-epoxy tooling panel with thickness of 6 mm was placed 100 mm from UV source in air and was exposed to a total dose of 10±0.5 J/cm² (C range). After activation, the sample exhibited a water contact angle of 40° (Table 1).

The panel was then sprayed with a solution of 20% B[DMA]DS in n-heptane at temperature 50° C. and RH 2% and dried at the same conditions. The water contact angle of the panel after this stage has increased to 105° (Table 1). This indicates the hydrophobization of the surface, and confirms the surface modification. Release properties of the sample are presented in Table 4.

### EXAMPLE 12

A polyolefin film (homopolymer polypropylene with mica in the core) was activated by corona discharge using plastic-insulated steel-wire electrode with gap at 2 mm and at energy of 0.18 J/mm². After activation, the water contact angle of the surface dropped to 53°. A curable composition consisting of the 100% B[DMA]MS was spread by a roller onto the surface of activated polypropylene film at room temperature 23° C. and RH 60% and dried at the same conditions. Release properties of the sample are presented in Table 5.

### EXAMPLE 13

Example 12 was repeated, except that a curable composition was prepared from the following components:

| | Composition |
|---|---|
| Component | (Parts by Weight) |
| B[DMA]MS | 98 |
| Dibutyltin diacetate | 2 |

The curable composition was spread by the roller onto the surface of activated polypropylene film at room temperature 23° C. and RH 60% and dried at the same conditions. Release properties of the sample are presented in Table 5.

### EXAMPLE 14

Example 12 was repeated, except that a curable composition was prepared from the following components:

| | Composition |
|---|---|
| Component | (Parts by Weight) |
| B[DMA]DS | 77 |
| MTMS | 20 |
| Dibutyltin diacetate | 2 |
| PMHS | 1 |

The curable composition was spread by the roller onto the surface of activated polypropylene film at room temperature 23° C. and RH 60% and dried at the same conditions. After curing the film was rinsed with heptane at room conditions. Release properties of the sample are presented in Table 5.

### EXAMPLE 15

Example 12 was repeated, except that a curable composition was prepared from the following components:

| | Composition |
|---|---|
| Component | (Parts by Weight) |
| B[DMA]DS | 65 |
| MTMS | 32 |
| Dibutyltin diacetate | 2 |
| PMHS | 1 |

The curable composition was spread by the roll on the surface of activated polypropylene film at room temperature 23° C. and RH 60% and dried at the same conditions. After curing the film was rinsed with heptane at room conditions. Release properties of the sample are presented in Table 5.

EXAMPLE 16

Example 12 was repeated, except that a curable composition was prepared from the following components:

| | Composition |
|---|---|
| Component | (Parts by Weight) |
| B[DMA]DS | 57 |
| MTMS | 40 |
| Dibutyltin diacetate | 2 |
| PMHS | 1 |

The curable composition was spread by the roll on the surface of activated polypropylene film at room temperature 23° C. and RH 60% and dried at the same conditions. After curing the film was rinsed with heptane at room conditions. Release properties of the sample are presented in Table 5.

TABLE 1
Water contact angle of the samples

| | Water Contact Angle [deg.] | | |
|---|---|---|---|
| Substrate | Pristine | Activated | Silylated/Coated |
| Polypropylene | 79 ± 2 | 53 ± 2 | 103 ± 2 |
| Poly (ethylene terephthalate) | 73 ± 2 | 30 ± 1 | 104 ± 2 |
| Mylar ® | | | |
| Fiberglass-epoxy tooling panel | 87 ± 2 | 40 ± 3 | 105 ± 2 |

TABLE 2
Release characteristics for the Polypropylene films. Tape C4704

| | | | | Release force after | Zippy or slick-stick |
|---|---|---|---|---|---|
| | | | Release force after aging | aging (20 hr, 10-lb | sound (no aging/after |
| | Percent | Release force | (20 hr, 10-lb load, | load, 70° C.) [g/in- | 24° C. aging/after 70° C. |
| Example | retain | [g/in-width] | 24° C.)[g/in-width] | width] | aging) |
| Control | 70 ± 5 | ˜1750 | — | — | Yes |
| Example 1 | 95 ± 3 | 30 ± 3 | 33 ± 4 | 52 ± 8 | None |
| Example 2 | 96 ± 2 | 23 ± 4 | 22 ± 2 | 29 ± 4 | None |
| Example 3 | 97 ± 4 | 30 ± 3 | 29 ± 4 | 48 ± 5 | None |
| Example 4 | 99 ± 1 | 22 ± 1 | 28 ± 4 | 44 ± 14 | None |
| Example 5 | 96 ± 2 | 26 ± 2 | 27 ± 1 | 42 ± 5 | None |
| Example 6 | 98 ± 1 | 22 ± 1 | 26 ± 1 | 36 ± 1 | None |
| Example 7 | 96 ± 1 | 22 ± 2 | 26 ± 2 | 39 ± 1 | None |
| Example 8 | 95 ± 1 | 28 ± 3 | 27 ± 2 | 51 ± 6 | None |

TABLE 3
Release characteristics for Poly (ethylene terephthalate) MYLAR ® films. Tape C4704

| | | | Release force after aging | Release force after aging | Zippy or slick-stick |
|---|---|---|---|---|---|
| | Percent | Release force | (20 hr, 10-lb load, 24° C.) | (20 hr, 10-lb load, 70° C.) | sound (no aging/after |
| Example | retain | [g/in-width] | [g/in-width] | [g/in-width] | 24° C. aging/after 70° C. aging) |
| Control | 65 ± 2 | ˜2000 | — | — | Yes |
| Example 9 | 98 ± 3 | 30 ± 3 | 31 ± 3 | 88 ± 18 | None-Low |
| Example 10 | 96 ± 3 | 27 ± 4 | 25 ± 4 | 76 ± 7 | None-Low |

TABLE 4
Release characteristics for Fiberglass-epoxy tooling panel. Tape C4704

| | | | Release force after aging | Release force after aging | Zippy or slick-stick |
|---|---|---|---|---|---|
| | Percent | Release force | (20 hr, 10-lb load, 24° C.) | (20 hr, 10-lb load, 70° C.) | sound (no aging/after |
| Example | retain | [g/in-width] | [g/in-width] | [g/in-width] | 24° C. aging/after 70° C. aging) |
| Control | 66 ± 5 | ˜2072 | — | — | Yes |
| Example 11 | 86 ± 3 | 67 ± 2 | — | — | None-Low |

TABLE 5
Release characteristics for Polypropylene films. Tapes: C4704, HD11F4 and TESA ® 7475

| | | | | Release force | Release force | Zippy or slick-stick |
|---|---|---|---|---|---|---|
| | | | | after aging (20 hr, | after aging (20 hr, | sound (no aging/ |
| | | Percent | Release | 10-lb load, | 10-lb load, 70° C.) | after 24° C. aging/ |
| Example | Testing tape | retain | force [g/in-width] | 24° C.)[g/in-width] | [g/in-width] | after 70° C. aging) |
| Example 12 | C4704 | 91 ± 3 | 21 ± 2 | 22 ± 3 | 46 ± 9 | None |
| | HD11F4 | 90 ± 3 | 24 ± 3 | 32 ± 2 | 52 ± 10 | None |
| Example 13 | C4704 | 93 ± 3 | 20 ± 2 | 20 ± 1 | 34 ± 4 | None |
| | HD11F4 | 95 ± 2 | 26 ± 3 | 58 ± 7 | 91 ± 6 | None |
| Example 14 | TESA ® 7475 | 89 ± 4* | 32 ± 2 | 35 ± 3 | 39 ± 4 | None |
| Example 15 | TESA ® 7475 | 93 ± 3* | 34 ± 4 | 37 ± 3 | 41 ± 7 | None |
| Example 16 | TESA ® 7475 | 94 ± 2* | 36 ± 3 | 35 ± 3 | 45 ± 6 | None |

*Measured with C4704 adhesive tape

The invention has been described with reference to the preferred embodiment. Obviously, modifications and alterations will occur to others upon reading and understanding the proceeding detailed description. It is intended that the invention be construed as including all such modifications and alterations insofar as they come within the scope of the appended claims or the equivalents thereof.

What is claimed is:

1. A process for modifying the surface region of a solid polymeric or composite substrate comprising the steps of:
i) activating the surface region of the solid polymeric or composite substrate by forming reactive hydrogen groups that are chemically bonded to molecules in the surface region of the substrate; and
ii) silylating at least a portion of the reactive hydrogen groups with a silylating solution, wherein silicon groups of the silylating agent become chemically bonded to the molecules in the surface region of the solid polymeric or composite substrate.

2. The process according to claim 1, wherein reactive hydrogen groups are selected from the group consisting of OH, OOH, and COOH.

3. The process according to claim 1, wherein the activation step is done by exposing the solid polymeric or composite substrate to UV radiation and oxygen.

4. The process according to claim 1, wherein the activation step is done by exposing the solid polymeric or composite substrate to corona discharge.

5. The process according to claim 1, wherein the activation step is done by exposing the solid polymeric or composite substrate to a plasma discharge.

6. The process according to claim 1, wherein the silylating agent is incorporated through a vapor phase.

7. The process according to claim 1, wherein the silylating solution is a liquid.

8. The process according to claim 1, wherein the silylating solution is a silylating agent alone.

9. The process according to claim 1, wherein the silylating solution is a silylating agent with concentration ranging from about 1 to about 100%, along with a transport solvent.

10. The process according to claim 1, wherein the transport solvent is selected from the group consisting of: hydrocarbons, ketones, esters, and ethers and mixtures thereof.

11. The process according to claim 1, wherein the silylating agent is a monofunctional silylating agent selected from the group consisting of dimethylsilyldimethylamine, 1,1,3,3-tetramethyldisalazine, N,N-dimethylaminotrimethylsilane, N,N-diethylaminotrimethylsilane, and hexamethyldisilazane.

12. The process according to claim 1, wherein the silylating agent is a polyfunctional silylating agent selected from the group consisting of Bis(dimethylamino)methylsilane, Bis(dimethylamino)dimethylsilane, 1,2-Bis[(dimethylamino)dimethylsilyl]ethane, 1,1,3,3,5,-hexamethylcyclosilazane, tris(dimethylamino)methylsilane and tris(dimethylamino)silane.

13. The process according to claim 1, wherein the silylating step occurs at a temperature of about 20° C. to about 70° C.

14. A product having enhanced surface release properties produced by the process of claim 1.

15. A product produced by the process according to claim 1, wherein a water contact angle of the surface of the solid polymeric or composite substrate increases over that of an untreated surface of the same solid polymeric or composite substrate.

16. A product produced by the process according to claim 1, wherein a water contact angle of the surface of the solid polymeric or composite substrate increases by at least 10° over an untreated surface of the same solid polymeric or composite substrate.

17. A product produced by the process according to claim 1, wherein the force required to release the solid polymeric or composite substrate from an adhesive or tacky material is decreased over an untreated surface of the same solid polymeric or composite substrate.

18. A product produced by the process according to claim 1, wherein the solid substrate comprises polyolefines, styrene polymers, poly(vinyl chloride) and related polymers, poly(vinyl acetate) and related polymers, acrylic polymers, polyethers, polyamides and polyimides, polyesters, polyurethanes, polysilicone, polyepoxies or a fiberglass-epoxy panel.

19. A process for producing a product with a surface that exhibits release properties from adhesives, the process comprising the steps of:
i) activating the surface region of a solid polymeric or composite substrate by forming reactive hydrogen groups that are chemically bonded to polymeric or composite molecules in the surface region of the substrate; and
ii) silylating at least a portion of the reactive hydrogen groups with a silylating solution, wherein silicon groups of a silylating agent become chemically bonded to the polymeric or composite molecules in the surface region of the solid polymeric or composite substrate, while simultaneously polymerizing the silylating solution to form a coating on the surface of the solid polymeric or composite substrate.

20. The process according to claim 19, wherein reactive hydrogen groups are selected from the group consisting of OH, OOH, and COOH.

21. The process according to claim 19, wherein the activation step is done by exposing the solid polymeric or composite substrate to UV radiation and oxygen.

22. The process according to claim 19, wherein the activation step is done by exposing the solid polymeric or composite substrate to corona discharge.

23. The process according to claim 19, wherein the activation step is done by exposing the solid polymeric or composite substrate to a plasma discharge.

24. The process according to claim 19, wherein the silylating agent is incorporated through a vapor phase.

25. The process according to claim 19, wherein the silylating solution is a liquid.

26. The process according to claim 19, wherein the silylating solution is a silylating agent alone.

27. The process according to claim 19, wherein the silylating solution is a silylating agent and a transport solvent.

28. The process according to claim 19, wherein the silylating solution is a silylating agent and a catalyst.

29. The process according to claim 19, wherein the silylating solution is a silylating agent, along with a transport solvent and cross-linking agent.

30. The process according to claim 19, wherein the silylating solution is a silylating agent, along with a transport solvent, cross-linking agent and a catalyst.

31. The process according to claim 19, wherein the transport solvent is selected from the group consisting of hydrocarbons, ketones, esters, ethers and mixtures thereof.

32. The process according to claim 19, wherein the silylating agent is a monofunctional silylating agent selected from the group consisting of dimethylsilyldimethylamine, 1,1,3,3-tetramethyldisalazine, N,N-dimethylaminotrimethylsilane, N,N-diethylaminotrimethylsilane, and hexamethyldisilazane.

33. The process according to claim 19, wherein the silylating agent is a polyfunctional silylating agent selected from the group consisting of Bis(dimethylamino)methylsilane, Bis(dimethylamino)dimethylsilane, 1,2-Bis[(dimethylamino)dimethylsilyl]ethane, 1,1,3,3,5,-hexamethylcyclosilazane tris(dimethylamino)methylsilane and tris(dimethylamino)silane.

34. The process according to claim 19, wherein the cross linking agent is any alkoxysilane of the formula RₙSi(OR¹)₄₋ₙ

35. The process according to claim 19, wherein the catalyst is an alkoxytitanium derivative or a tin-derived ester.

36. The process according to claim 19, wherein the silylating step occurs at a temperature of from about 20° C. to about 70° C.

37. The process according to claim 19, wherein the silylating step occurs at a relative humidity of 30%-90%.

38. A solid polymeric or composite substrate product having enhanced surface release properties from adhesives produced by the process of claim 19.

39. A product produced by the process according to claim 19, wherein the water contact angle of the surface of the solid polymeric or composite substrate increases over that of an untreated surface of the same solid polymeric or composite substrate.

40. A product produced by the process according to claim 19, wherein the water contact angle of the surface of the solid polymeric or composite substrate increases by at least 10° over an untreated surface of the same solid polymeric or composite substrate.

41. A product produced by the process according to claim 20, wherein the force required to release the solid polymeric or composite substrate from an adhesive or tacky material is decreased over an untreated surface of the same solid polymeric or composite substrate.

42. A product produced by the process according to claim 20, wherein the solid substrate comprises polyolefins, styrene polymers, poly(vinyl chloride) and related polymers, poly(vinyl acetate) and related polymers, acrylic polymers, polyethers, polyamides and polyimides, polyesters, polyurethanes, polysilicone, polyepoxies or a fiberglass-epoxy panel.
